(19) United States
(12) Patent Application Publication
(10) Pub. No.: US 2025/0315567 A1
(43) Pub. Date: Oct. 9, 2025

(54) SITE VIABILITY ASSESSMENT APPARATUS AND ASSOCIATED METHOD

(71) Applicant: The Boeing Company, Arlington, VA (US)

(72) Inventors: Anthony Arnold, Brisbane (AU); Christopher Galea, Brisbane (AU)

(21) Appl. No.: 18/628,622

(22) Filed: Apr. 5, 2024

(51) Int. Cl. G06F 30/20; G06F 30/10; G06F 111/10

(52) U.S. Cl. CPC G06F 30/20; G06F 30/10; G06F 2111/10

(57) ABSTRACT

An apparatus for determining a viable site for a first object and associated method are disclosed. The apparatus includes a processor and memory that stores code executable by the processor to provide various processes. The apparatus includes receiving a digital model of a terrain including a plurality of elements with corresponding elevations within a predetermined area. The first object is configured to be positioned at a predetermined position within the predetermined area. The apparatus also includes determining a location of a second object at a predetermined time. The apparatus further utilizes a root finding method, to determine a minimum height of the first object above the predetermined position to establish a line of sight with the second object at the predetermined time. The apparatus additionally determines whether the minimum height is within a threshold height of the first object and identifies the predetermined position as a viable site for the first object if it is within the threshold height.

### FIELD

This disclosure relates generally to a site viability assessment for an object and more particularly to a site viability assessment for an object at a minimum height above a predetermined position.

### BACKGROUND

Predicting viable sites for placement of an object, such as a solar tracking device, relative to a second object, such as the sun, is often difficult due to variability in surface topology of a planetary body. In the case of a solar tracking device, it is necessary to determine whether the solar tracking device, located a site, would be exposed to an appropriate amount of light from the sun to meet mission requirements. Traditional methods rely on fixed location measurements to determine areas where the sun is visible at a fixed location and time by the solar tracking device. However, fixed location measurements are limited to determinations at a fixed location and fail to provide insights into a height above a fixed location that would be required to see the sun at any of various fixed times.

### SUMMARY

The subject matter of the present application has been developed in response to the present state of the art, and in particular, in response to the problems of and needs created by, or not yet fully solved by, existing site viability assessment processes and procedures. Generally, the subject matter of the present application has been developed to provide a site viability assessment apparatus and associated method that overcomes at least some of the above-discussed shortcomings of prior art techniques.

Disclosed herein in an apparatus for determining a viable site for a first object. The apparatus includes a processor and a memory that stores code executable by the processor to receive a digital model of a terrain defining a predetermined area. The digital model of the terrain includes a plurality of elements having a corresponding elevation within the predetermined area. The first object is configured to be positioned at a predetermined position within the predetermined area. The apparatus also includes memory that stores code executable by the processor to determine a location of a second object at a predetermined time. The apparatus further includes memory that stores code executable by the processor to apply a root finding method, based on the digital model of the terrain, to determine a minimum height of the first object above the predetermined position to establish a line of sight with the second object at the predetermined time. The apparatus additionally includes memory that stores code executable by the processor to determine whether the minimum height of the first object is within a threshold height of the first object. The apparatus also includes memory that stores code executable by the processor to identify the predetermined position as a viable site for the first object based on whether the minimum height of the first object is within the threshold height of the first object. The preceding subject matter of this paragraph characterizes example 1 of the present disclosure.

The root finding method includes defining an initial search space for the first object defining an initial minimum height and an initial maximum height. At the initial minimum height, the first object lacks line of sight with the second object. At the initial maximum height, the first object established line of sight with the second object. The root finding method also includes applying a root finding calculation to determine an intermediate height of the first object by dividing the initial search space between the initial minimum height and the initial maximum height. The root finding method further includes defining a current search space for the first object based on the root finding calculation. The current search space defining a current minimum height and a current maximum height. The root finding method additionally includes iteratively refining the current search space of the first object using the root finding calculation to converge upon the minimum height of the first object above the predetermined position to establish line of sight with the second object. The preceding subject matter of this paragraph characterizes example 2 of the present disclosure, wherein example 2 also includes the subject matter according to example 1, above.

The step of iteratively refining the current search space includes defining a tolerance value configured to control a precision of the minimum height, such that iteratively refining the current search space continues until a difference between the current maximum height and the current minimum height is less than or equal to the tolerance value. The preceding subject matter of this paragraph characterizes example 3 of the present disclosure, wherein example 3 also includes the subject matter according to example 2, above.

The root finding method includes optimizing within the initial search space using an optimization value to determine an optimized search space for the first object defining an optimized minimum height and an optimized maximum height. The step of applying the root finding calculation includes determining the intermediate height of the first object by dividing the optimized search space between the optimized minimum height and the optimized maximum height. The preceding subject matter of this paragraph characterizes example 4 of the present disclosure, wherein example 4 also includes the subject matter according to example 2, above.

The root finding method includes a bisection method. The preceding subject matter of this paragraph characterizes example 5 of the present disclosure, wherein example 5 also includes the subject matter according to any of examples 2-4, above.

The first object is a solar-tracking device. The second object is the sun. The preceding subject matter of this paragraph characterizes example 6 of the present disclosure, wherein example 6 also includes the subject matter according to any of examples 1-5, above.

The digital model of the terrain includes a representation of a surface topology of a planetary body. Each one of the plurality of elements within the predetermined area is associated with specific geographical coordinates. The preceding subject matter of this paragraph characterizes example 7 of the present disclosure, wherein example 7 also includes the subject matter according to any of examples 1-6, above.

The line of sight established between the first object and the second object is configured to transmit at least one of various signals between the first object and the second object, including at least one of electromagnetic waves, communication waves, or acoustic waves. The preceding subject matter of this paragraph characterizes example 8 of the present disclosure, wherein example 8 also includes the subject matter according to any of examples 1-7, above.

When the minimum height of the first object is within the threshold height, the code stored by the memory is executable by the processor to design a signal-receiving product or a signal-transmitting product based on the first object. The signal-receiving product or the signal-transmitting product is configured to be positioned at the predetermined position within the predetermined area. A height of the signal-receiving product or the signal-transmitting product is configured to be at least the minimum height. The preceding subject matter of this paragraph characterizes example 9 of the present disclosure, wherein example 9 also includes the subject matter according to any of examples 1-8, above.

When the minimum height of the first object is beyond the threshold height, the memory stores code executable by the processor to define a subsequent position that the first object is configured to be positioned within the predetermined area. The memory also stores code executable by the processor to apply the root finding method to determine a subsequent minimum height of the first object above the subsequent position to establish the line of sight with the second object. The memory further stores code executable by the processor to determine whether the subsequent minimum height is within the threshold height of the first object. Additionally, the memory stores code executable by the processor to identify the subsequent position as a viable site for the first object based on whether the subsequent minimum height of the first object is within the threshold height of the first object. The preceding subject matter of this paragraph characterizes example 10 of the present disclosure, wherein example 10 also includes the subject matter according to any of examples 1-9, above.

The memory stores code executable by the processor to determine a second location of the second object at a second predetermined time. The method also stores code executable by the processor to apply the root finding method to determine a second minimum height of the first object above the predetermined position to establish the line of sight with the second object. The method further stores codes executable by the processor to determine whether the second minimum height of the first object is within the threshold height of the first object. The preceding subject matter of this paragraph characterizes example 11 of the present disclosure, wherein example 11 also includes the subject matter according to any of examples 1-10, above.

Further disclosed herein is a method for determining a viable site of a first object. The method includes receiving a digital model of a terrain defining a predetermined area. The digital model of the terrain including a plurality of elements having a corresponding elevation within the predetermined area. The first object is configured to be positioned at a predetermined position within the predetermined area. The method also includes determining a location of the second object at a predetermined time. The method further includes applying a root finding method, based on the digital model of the terrain, to determine a minimum height of the first object above the predetermined position to establish a line of sight with the second object at the predetermined time. The method additionally includes determining whether the minimum height of the first object is within a threshold height of the first object. The method also includes identifying the predetermined position as a viable site for the first object based on whether the minimum height of the first object is within the threshold height of the first object. The preceding subject matter of this paragraph characterizes example 12 of the present disclosure.

The root finding method includes defining an initial search space for the first object including an initial minimum height and an initial maximum height. At the initial minimum height, the first object lacks line of sight with the second object. At the initial maximum height, the first object established line of sight with the second object. The root finding method also includes applying a root finding calculation to determine an intermediate height of the first object by dividing the initial search space between the initial minimum height and the initial maximum height. The root finding method further includes defining a current search space for the first object based on the root finding calculation. The current search space including a current minimum height and a current maximum height. The root finding method additionally includes iteratively refining the current search space of the first object using the root finding calculation to converge upon the minimum height of the first object above the predetermined position to establish line of sight with the second object. The preceding subject matter of this paragraph characterizes example 13 of the present disclosure, wherein example 13 also includes the subject matter according to example 12, above.

The step of iteratively refining the current search space includes defining a tolerance value configured to control a precision of the minimum height, such that iteratively refining the current search space continues until a difference between the current maximum height and the current minimum height is less than or equal to the tolerance value. The preceding subject matter of this paragraph characterizes example 14 of the present disclosure, wherein example 14 also includes the subject matter according to example 13, above.

When the minimum height of the first object is within the threshold height, the method includes designing a product based on the first object. The product is configured to be positioned at the predetermined position within the predetermined area. A height of the product is configured to be at least the minimum height. The preceding subject matter of this paragraph characterizes example 15 of the present disclosure, wherein example 15 also includes the subject matter according to any of examples 12-14, above.

When the minimum height of the first object is within the threshold height, the method includes fabricating a product based on the first object. The product is configured to be positioned at the predetermined position within the predetermined area. A height of the product is configured to be at least the minimum height. The preceding subject matter of this paragraph characterizes example 16 of the present disclosure, wherein example 16 also includes the subject matter according to any of examples 12-15, above.

When the minimum height of the first object is within the threshold height, the method includes installing a product based on the first object at the predetermined position within the predetermined area. A height of the product above the predetermined position is at least the minimum height. The preceding subject matter of this paragraph characterizes example 17 of the present disclosure, wherein example 17 also includes the subject matter according to any of examples 12-16, above.

Further disclosed herein is a program product for determining a viable site for a first object including a non-transitory computer-readable storage medium storing executable code. The code is configured to be executable by a processor to perform operations including receiving a digital model of a terrain defining a predetermined area. The digital model of the terrain including a plurality of elements having a corresponding elevation within the predetermined area. The first object is configured to be positioned at a predetermined position within the predetermined area. The code is also configured to be executable by the processor to perform operations including determining a location of the second object at a predetermined time. The code is further configured to be executable by the processor to perform operations including applying a root fining method, based on the digital model of the terrain, to determine a minimum height of the first object above the predetermined position to establish a line of sight with the second object at the predetermined time. The code is additionally configured to be executable by the processor to perform operations including determining whether the minimum height of the first object is within a threshold height of the first object. The code is also configured to be executable by the processor to perform operations including identifying the predetermined position as a viable site for the first object based on whether the minimum height of the first object is within the threshold height of the first object. The preceding subject matter of this paragraph characterizes example 18 of the present disclosure.

When the minimum height of the first object is within the threshold height, the program product includes designing a product based on the first object. The product is configured to be positioned at the predetermined position within the predetermined area. A height of the product is configured to be at least the minimum height. The preceding subject matter of this paragraph characterizes example 19 of the present disclosure, wherein example 19 also includes the subject matter according to example 18, above.

The root finding method includes defining an initial search space for the first object including an initial minimum height and an initial maximum height. At the initial minimum height, the first object lacks line of sight with the second object. At the initial maximum height, the first object established line of sight with the second object. The root finding method also includes applying a root finding calculation to determine an intermediate height of the first object by dividing the initial search space between the initial minimum height and the initial maximum height. The root finding method further includes defining a current search space for the first object based on the root finding calculation. The current search space including a current minimum height and a current maximum height. The root finding method additionally includes iteratively refining the current search space of the first object using the root finding calculation to converge upon the minimum height of the first object above the predetermined position to establish line of sight with the second object. The preceding subject matter of this paragraph characterizes example 20 of the present disclosure, wherein example 20 also includes the subject matter according to any of examples 18-19, above.

The described features, structures, advantages, and/or characteristics of the subject matter of the present disclosure may be combined in any suitable manner in one or more examples, including embodiments and/or implementations. In the following description, numerous specific details are provided to impart a thorough understanding of examples of the subject matter of the present disclosure. One skilled in the relevant art will recognize that the subject matter of the present disclosure may be practiced without one or more of the specific features, details, components, materials, and/or methods of a particular example, embodiment, or implementation. In other instances, additional features and advantages may be recognized in certain examples, embodiments, and/or implementations that may not be present in all examples, embodiments, or implementations. Further, in some instances, well-known structures, materials, or operations are not shown or described in detail to avoid obscuring aspects of the subject matter of the present disclosure. The features and advantages of the subject matter of the present disclosure will become more fully apparent from the following description and appended claims, or may be learned by the practice of the subject matter as set forth hereinafter.

### BRIEF DESCRIPTION OF THE DRAWINGS

In order that the advantages of the subject matter may be more readily understood, a more particular description of the subject matter briefly described above will be rendered by reference to specific examples that are illustrated in the appended drawings. Understanding that these drawings depict only typical examples of the subject matter, they are not therefore to be considered to be limiting of its scope. The subject matter will be described and explained with additional specificity and detail through the use of the drawings, in which:

FIG. 1 is a schematic diagram of one example of an apparatus for determining a viable site for a first object, according to one or more examples of the present disclosure;

FIG. 2 is a schematic side elevation view of a first object at a predetermined position, relative to a second object, at a predetermined time, according to one or more examples of the present disclosure;

FIG. 3A is a schematic side elevation view of a solar tracking device at a predetermined position, relative to the sun, at a predetermined time, according to one or more examples of the present disclosure;

FIG. 3B is a schematic side elevation view of the solar tracking device at the predetermined position of FIG. 3A, relative to the sun, at a second predetermined time, according to one or more examples of the present disclosure;

FIG. 4 is a schematic side elevation view of a first object at a predetermined position and the first object at a subsequent position, relative to a second object, at a predetermined time, according to one or more examples of the present disclosure;

FIG. 5 is a schematic flow diagram of a root finding method to determine a minimum height of a first object, above a predetermined position, to establish a line of sight with a second object at a predetermined time, according to one or more examples of the present disclosure; and

FIG. 6 is a schematic flow diagram of a method for determining a viable site for a first object, according to one or more examples of the present disclosure.

### DETAILED DESCRIPTION

Reference throughout this specification to “one example,” “an example,” or similar language means that a particular feature, structure, or characteristic described in connection with the example is included in at least one example of the subject matter of the present disclosure. Appearances of the phrases “in one example,” “in an example,” and similar language throughout this specification may, but do not necessarily, all refer to the same example. Similarly, the use of the term “implementation” means an implementation having a particular feature, structure, or characteristic described in connection with one or more examples of the subject matter of the present disclosure, however, absent an express correlation to indicate otherwise, an implementation may be associated with one or more examples.

Disclosed herein are examples of an apparatus and associated method for determining a viable site for a first object. The following provides some features of at least one example of the apparatus and associated method. The apparatus may be used to identify viable sites for a first object on a planetary body. A viable site, as used herein, refers to a location or position where an object (e.g., solar tracking device) can be placed or positioned to meet specific criteria or requirements. The determination of site viability is at least partially determined by calculating a minimum height of the first object needed for an unobstructed line a sight with a second object, like the sun. Accordingly, the apparatus is configured to determine a minimum height needed for a first object to have a clear line of sight with a second object at a specified time. Utilizing a root finding method, the apparatus calculates the minimum height by converging on the required elevation for the first object above a surface, ensuring a clear line of sight with the second object at a given time. Essentially, the root finding method helps to find the height above a fixed location necessary to achieve visibility of the second object at a fixed time. The apparatus then assesses whether the minimum height falls within a predetermined threshold of the first object. If the minimum height is within the threshold, the predetermined position is identified by the apparatus as a viable site for the first object, based on the minimum height requirements. Other factors, including mission-specific considerations, may also contribute to assessing site viability for the first object.

In one example, the apparatus is used to determine viable sites for a solar tracking device (i.e. first object), relative to the sun (i.e. second object), on a planetary body, such as the moon. With knowledge of the sun's location, relative to the planetary body, and a model of the surface topology of the planetary body, the radiant flux incident at a surface point, or an elevation about a surface point, can be predicted, accounting for the sun's distance and any shadows caused by the surface topology. Predicting the amount of light received at a surface point, or a height above the surface point, is useful for planning the placement of solar tracking devices, such as solar panels. Expanding the range of viable sites for the solar tracking device, the apparatus identifies regions where a surface location receives insufficient sunlight for mission requirements, but where elevations above the surface provide optimal sunlight expose. Accordingly, the apparatus may be used to determine a minimum height required for a solar tracking device to establish a line of sight with the sun, accounting for terrain, at a specific location and time. Considering the common constraint for a maximum elevation for solar tracking devices, the apparatus verifies whether the minimum height falls within a predetermined threshold of the solar tracking device.

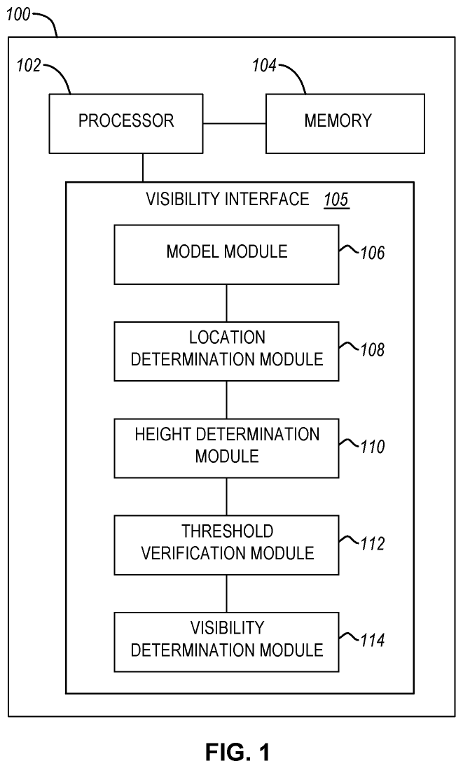

Referring to FIG. 1, an apparatus 100 for determining a viable site for a first object is shown. The apparatus 100 includes a processor 102, a memory 104, and a viability interface 105. In various embodiments, non-transitory computer readable instructions (i.e., code) stored in the memory 104 (i.e., storage media) cause the processor 102 to determine a viable site for the first object. The processor 102 (e.g., central processing unit) may be incorporated into various computing devices, such as a desktop computer, a laptop computer, a tablet computer, a smart phone, a smart watch, a smart TV, etc. In some examples, a web-based portal may facilitate access to the processor 102, allowing the apparatus 100 to be utilized remotely, regardless of a physical location in relation to the processor 102. The viability interface 105 may include a model module 106, a location determination module 108, a height determination module 110, a threshold verification module 112, and a viability determination module 114, which are described in more detail below.

In one example, the model module 106 is configured to receive a digital model of a terrain. The digital model of the terrain includes data about the terrain of the target planetary body where the first object is configured to be positioned. The target planetary body may be a planet, such as Earth or Mars, or a celestial body associated with a planet, such as the moon. In some examples, the digital model of the terrain includes a predetermined area of the planetary body. That is, in some examples, only a relevant portion of the digital model of the terrain for the determination of site viability is necessary for efficient and accurate analysis. The first object is configured to be positioned at a predetermined position within the predetermined area. In other words, the predetermined area is the relevant portion of the digital model of the terrain because it includes the predetermined position of the first object as well as the terrain surrounding the predetermined position. The digital model of the terrain includes a plurality of elements, each one of the plurality of elements having a corresponding elevation. Depending on the specifics of the predetermined area, the plurality of elements may include natural topographical elements, such as mountains, craters, valleys, and forests, as well as anthropogenic elements like building, roads, and infrastructure, if applicable. The digital model of the terrain includes three-dimensional data of the terrain, including the corresponding elevation for each one of the plurality of elements, which provides the vertical position or height of each element relative to a reference point, typically a surface level. Understanding the three-dimensional data of the terrain allows for more accurate terrain analysis. For example, the elevation of each one of the plurality of elements is a key factor for determining shadow patterns caused by natural and man-made structures, which is important for predicting radiant flux and optimizing the placement of objects like solar tracking devices.

The location determination module 108 is configured to determine a location of a second object, relative to the target planetary body, at a predetermined time. That is, the location of the second object has a temporal dimension, allowing the assessment to be determined at any predetermined time, including real-time or future-oriented assessments. The location of the second object at the predetermined time is necessary to understand the relative position of the second object with respect to the first object and any obstructing elements of the terrain between the second object and the first object. In some example, the location of the second object may be determined using reference materials. For example, the utilization of planetary ephemerides—tables or datasets detailing the positions of celestial bodies across a defined timeframe—may be used to determine the location of a second object that is a celestial body. Planetary ephemerides may include the position of the relevant celestial body including their coordinates, distances, and other relevant data. Using the location of the second object and the elevation of any terrain in the predetermined area, as determined by the model module 106, the apparatus 100 utilizes ray tracing to determine if the second object is fully visible from a given height by testing if the line of sight between the minimum height and the second object intersect with any terrain. If the first object is not visible, then the height determination module 110 may be used.

The height determination module 110 is configured to apply a root finding method to determine a minimum height of the first object, above the predetermined position, which is used to establish a line of sight with the second object at the predetermined time. In other words, the problem of finding the line of sight is formulated as a root finding problem, seeking a solution to the equation of h_v−h equals zero, where h_v is the line of sight height and h is the minimum height (i.e., candidate height). The root finding method is constrained between two heights, h_a and h_b, which are iteratively redefined through the root finding method to converge above the minimum height, h.

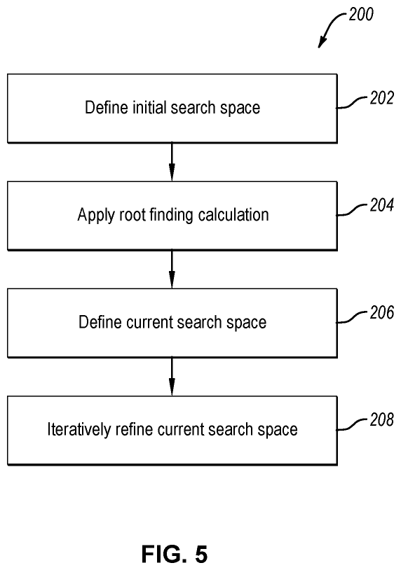

Specifically, the root finding method 200, as shown in FIG. 5 and according to one example, includes (block 202) defining an initial search space for the first object. The initial search space is defined by an initial minimum height (i.e., h_min) and an initial maximum height (i.e., h_max), both at heights above the predetermined position. During this step, h_a is initially equal to h_min and h_b is initially equal to h_max. The initial minimum height and the initial maximum height define the boundaries of the initial search space, constraining the search space within initial bracketing values. At the initial minimum height, the first object lacks line of sight with the second object. Conversely, at the initial maximum height, the first object establishes line of sight with the second object. In some examples, the initial minimum height and the initial maximum height are unknown and can be set at zero (i.e., the predetermined position) and infinity, respectively. In other cases, the initial minimum height and the initial maximum height are predetermined.

In some cases, the step of defining the initial search space can be additionally optimized before applying the root finding calculation. Specifically, the initial search space is optimized, using an optimization value (i.e., ΔH) to determine, an optimized (i.e., narrower) search space for the first object. The optimized search space defines an optimized minimum height and an optimized maximum height. Accordingly, the initial minimum height and the initial maximum height can be optimized by increasing or decreasing the height, respectively, by the optimization value, ensuring that the optimized minimum height lacks line of sight with the second object and the optimized maximum height establishes line of sight with the second object. The optimization value may be any of various values, and may depend on the application of the root finding method. For example, the optimization value may be a value such as 1 meter, 1 foot, 1 centimeter, etc.

The root finding method 200 also includes (block 204) applying a root finding calculation to determine an intermediate height (i.e., h_c) of the first object. The intermediate height is determined by dividing the initial search space between the initial minimum height and the initial maximum height. In some examples, the intermediate height is the midpoint between the initial minimum height and the initial maximum height. The root finding method 200 further includes (block 206) defining a current search space for the first object based on the root finding calculation. The current search space is defined by the current minimum height and the current maximum height. At the current minimum height, the first object lacks line of sight with the second object. Conversely, at the current maximum height, the first object establishes line of sight with the second object. Accordingly, if at the intermediate height the first object lacks line of sight with the second object, the current minimum height is set at the intermediate height, h_a, and the current maximum height the height h_b. However, if at the intermediate height the first object establishes line of sight with the second object, the current maximum height is set at the intermediate height, h_b, and the current minimum height is set at the height h_a. The root finding method 200 also includes (block 208) iteratively refining the current search space of the first object, using the root finding calculation, to converge upon the minimum height of the first object above the predetermined position to establish line of sight with the second object. That is, the current search space is iteratively refined until the minimum height is found. In other words, the difference between h_a and h_b is near zero or within a defined tolerance, and h_c is appropriately equal to h, the minimum height of the first object.

In some examples, the step of iteratively refining the current search space includes defining a tolerance value (i.e., €) configured to control the precision of the minimum height. That is, refinement continues until a difference between the current minimum height and the current minimum height is less than or equal to the tolerance value. In other words, h_b minus h_a is less than or equal to the tolerance value €. Accordingly, the precision of the solution to the root finding method can be controlled by the tolerance value €. Increasing the size of the tolerance value € may result in faster search times, with a trade-off of a less precise solution.

In some examples, the root finding method 200 is a bisection method. The bisection method iteratively narrows down the search interval by halving the search interval at each iteration until the height is found within a specified tolerance. In other examples, the root finding method 200 may be an iterative method, such as a fixed-point iteration, or an iterative technique using derivatives of a function.

The apparatus 100 also includes the threshold verification module 112, which determines whether the minimum height, calculated by the root finding method, is within a threshold height of the first object. That is, the threshold verification module 112 evaluates whether the minimum height falls within a predefined acceptable range or limit of the first object. This ensures that the minimum height aligns with operational requirements, safety consideration, manufacturing requirements, or any other specified criteria essential for the functioning of the first object.

The viability determination module 114, identifies whether or not the predetermined position is a viable site for the first object, based on the results from the threshold verification module 112. If the minimum height of the first object is within the threshold height of the first object, signaling compliance with safety and operational requirements, the predetermined position is qualified as a viable site for the first object. However, if the minimum height surpasses the threshold height, the threshold verification module 112 deems the predetermined position as unsuitable, thereby indicating that the predetermined position does not meet the requisite criteria for a viable site for the first object.

When the minimum height of the first object is within the threshold height, the apparatus 100 may, in some examples, design a product based on the first object. The product may be either a signal-receiving product, configured to receive a signal from the second object, or a signal-transmitting product, configured to transmit a signal from the second object. The product is designed to be positioned at the predetermined position within the predetermined area. Additionally, the height of the product is designed to be at least the minimum height. In some examples, the height of the product may be fixed, such that the product height is constant. In other examples, the height of the product is designed to be adjustable, provided that the adjustable range accommodates heights equal to or exceeding the minimum height requirement. Moreover, in some examples, the apparatus 100 may be used to simulate and model the behavior of the product in various scenarios. Simulating behavior may help predict how the product will perform under different conditions and identify potential challenges or optimizations for the product.

A program product, a tangible and non-transitory computer-readable storage medium that stores executable code, may also be used for determining site viability for a first object, as described above. The program product is a physical or electronic medium, such as a hard drive, solid-state drive, CD-ROM, or a downloadable file, that contains the software code necessary for a computer or processor to execute specific operations, such as the operations of the viability interface 105.

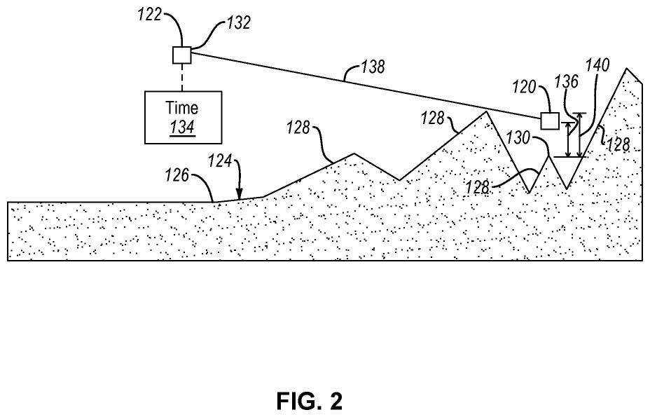

Shown in FIG. 2, according to some examples, is one application of the apparatus 100 for determining a viable site for a first object 120. The first object 120, as used herein, refers to a primary object for which the apparatus 100 is determining a viable site. The first object 120 is positioned at a predetermined position 130 within a predetermined area 126 on digital model of a terrain 124. The first object 120 may include, but is not limited to a digital representation of, a structure, an equipment, a sensor, or any other object requiring a specific line of sight to a second object. The first object 120 may be physically affixed to the predetermined position 130 or may be configured to be positioned above the predetermined position 130, without direct contact to the predetermined position 130, such as a drone or a bridge that hovers over the predetermined position 130 without physical attachment. Regardless of physical or non-physical attachment at the predetermined position 130, the first object 120 has a fixed (i.e., stationary) position, relative to the second object 122. The first object 120 is configured to be placed at a minimum height 136 above the predetermined position 130, in order to establish a line of sight 138 with a second object 122. Moreover, in some examples, the first object 120 has a threshold height 140, which defines the maximum elevation in which the first object 120 can be placed.

The second object 122, as used herein, refers to an object that needs to establish the line of sight 138 with the first object 120 at a predetermined time 134. In some examples, the second object 122 is configured to be movable over a time period, such that a location 132 of the second object 122 is dependent on the predetermined time 134. In other words, due to a dynamic nature of the second object 122, the line of sight 138 with the first object 120 is variable at different points in time. Accordingly, the line of sight 138 is calculated based on the location 132 of the second object 122 at the predetermined time 134. Additional calculations, based on a location 132 of the second object 122 at other predetermined times may also be used to determine additional line of sights with the first object 120 over a range of temporal instances. Moreover, one of either the first object 120 or the second object 122 is a signal-transmit object, while the other serves as a signal-receiving counterpart. That is, the first object 120 and the second object 122 are configured to facilitate the transmission and reception of signals between one another. Accordingly, the line of sight 138 established between the first object 120 and the second object 122 is configured to transmit at least one of various signals between the objects. For example, the line of sight 138 may transmit electromagnetic waves, communication waves, and/or acoustic waves, between the first object 120 and the second object 122. Electromagnetic waves may include radio waves, infrared waves, visible light, ultraviolet light, gamma rays, etc. Communication waves may include radio waves used for communication purposes such as AM/FM radio waves, cellular signals, Wi-Fi signals, Bluetooth signal, or satellite communication signals. Acoustic waves are mechanical waves that require a medium, such as air or water, to propagate and may include sound waves or sonar waves.

The apparatus 100 may be used to determine a minimum height 136 to establish a line of sight for any of various examples of first objects 120 with second objects 122. In some examples, the first object 120 may be a solar-tracking device, a weather station, a communication satellite, a surveillance camera, a drone, a structure, etc. Similarly, the second object 122 may encompass a celestial or planetary body, a satellite, a camera, a flying object, a person, etc.

The digital model of the terrain 124 includes a representation of a surface topology of a planetary body. That is, the model includes details of the planetary body's terrain elements, such as mountains, valleys, craters, and other topographical elements. The model may also include anthropogenic elements like building, roads, and infrastructure. Within the predetermined area 126, the plurality of elements 128, including any relevant topographical elements and the anthropogenic elements, are each associated with specific geographical coordinates. The geographical coordinates provide precise locational data, ensuring an accurate representation of each element of the plurality of elements within the predetermined area 126, relative to the first object 120 and the second object 122.

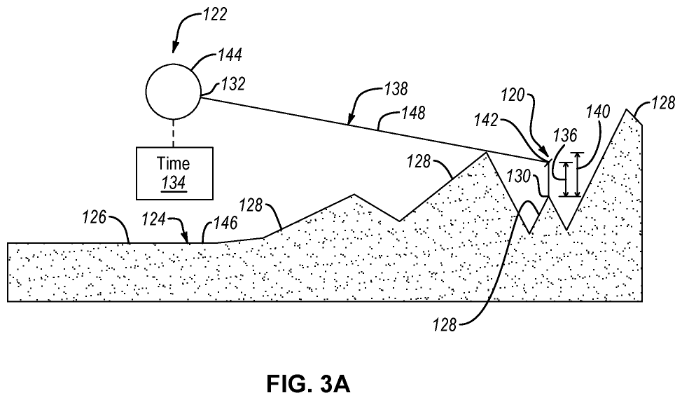

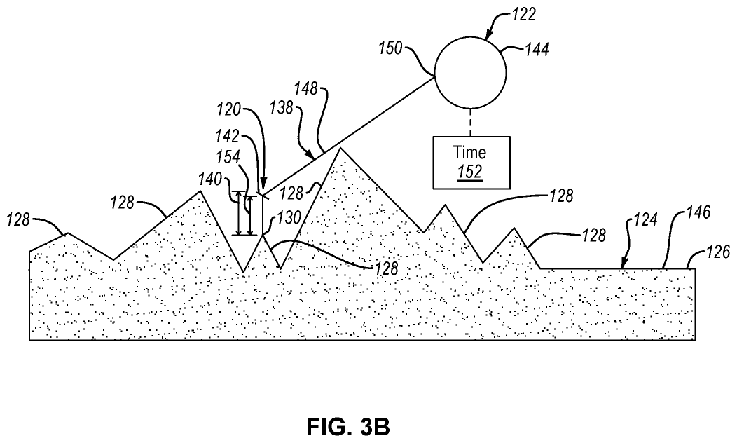

As shown in FIGS. 3A and 3B, in some examples, the first object 120 is a digital representation of a solar-tracking device 142 and the second object 122 is a digital representation of the sun 144. That is, the solar-tracking device 142 operates as a signal-receiving object that is configured to capture electromagnetic wave 148, specifically light waves, transmitted by the sun 144, which functions as the signal-transmitting object. In order to increase the number and locations of viable sites for the solar-tracking device 142, the apparatus 100 is configured to calculate a minimum height 136 that the solar-tracking device 142 requires to establish a line of sight 138 (i.e., sun-visibility height) with the sun 144. As the sun 144 is moving, relative to the solar-tracking device 142, the line of sight 138 is calculated at, and is specific to, the predetermined time 134. The digital model of the terrain 124, on which the solar-tracking device 142 is configured to be positioned, may be a planetary body 146, and in some cases is the moon. In some examples, the apparatus 100 may be used to identify sites on the moon which would be suitable for placing a photovoltaic array for power generation. Candidate sites may be chosen using other criteria and then vetted, using the apparatus 100, for suitable lighting conditions. Sites are deemed viable if the maximum period of darkness, where darkness is defined as a state in which the sun-visibility height exceeds the operating limitations of the photovoltaic array, over the mission time frame, is within mission constraints.

Referring to FIG. 3A, the sun 144 is at a location 132 at a predetermined time 134. Accordingly, the minimum height 136 for the solar-tracking device 142 is calculated, using the root finding method, based on the location 132 at the predetermined time 134. If the calculated minimum height 136 is below the threshold height 140 of the solar-tracking device 142, the predetermined position 130 is identified as a viable site for the solar-tracking device 142 at the predetermined time 134. Referring to FIG. 3B, the sun 144 is in a new location (e.g., a second location 150) relative to the solar-tracking device 142, at a second predetermined time 152. The root finding method is applied to determine a second minimum height 154 of the solar-tracking device 142 above the predetermined position 130 to establish the line of sight 138 with the sun 144 at the second predetermined time 152. If the second minimum height 154 is below the threshold height 140 of the solar-tracking device 142, the predetermined position 130 is identified as a viable site for the solar-tracking device 142 at the second predetermined time 152. Accordingly, the site viability of the solar-tracking device 142 is time-dependent, as it is based on the position of the sun 144 over a period of time. Therefore, in certain examples of second objects 122, the temporal dimension requires the utilization of the apparatus 100 to account for the second objects 122 in varying positions over diverse predetermined times. By collecting multiple data points, each associated with specific predetermined times and the corresponding required minimum heights for the first object 120, the apparatus enables the determination of site viability over an extended period. This temporal consideration ensures a comprehensive analysis that reflects the varying conditions, providing valuable insights into the suitability of a site for the first object across different points in time.

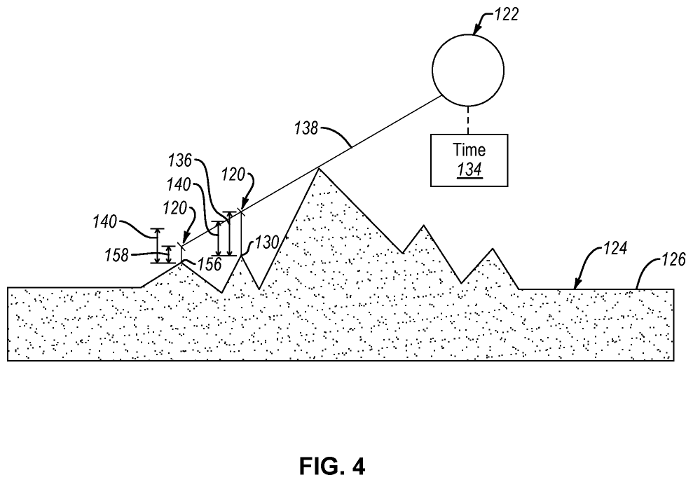

As shown in FIG. 4, the apparatus 100 may be used to determine various possible viable sites for the first object 120. That is, the apparatus 100 may be used to test for site viabilities at multiple positions within the predetermined area 126 at the predetermined time 134. Specifically, the minimum height 136, above the predetermined position 130, for the first object 120 is calculated at the predetermined time 134. As shown, the minimum height 136 at the predetermined position 130 is greater than the threshold height 140 for the first object 120, and therefore, the predetermined position 130 is not a viable site for the first object 120 at the predetermined time 134. Consequently, the apparatus 100 determines other possible viable sites for the first object 120, such as subsequent position 156. The root finding method is used to determine a subsequent minimum height 158 of the first object 120 above the subsequent position 156 to establish the line of sight 138 with the second object 122. As shown, the subsequent minimum height 158 is less than the threshold height 140 for the first object 120. Accordingly, the subsequent position 156 is a viable site for the first object 120 at the predetermined time 134. Moreover, the apparatus 100 may also be used to determine whether the subsequent position 156 is a viable site for the first object 120 at other periods of time.

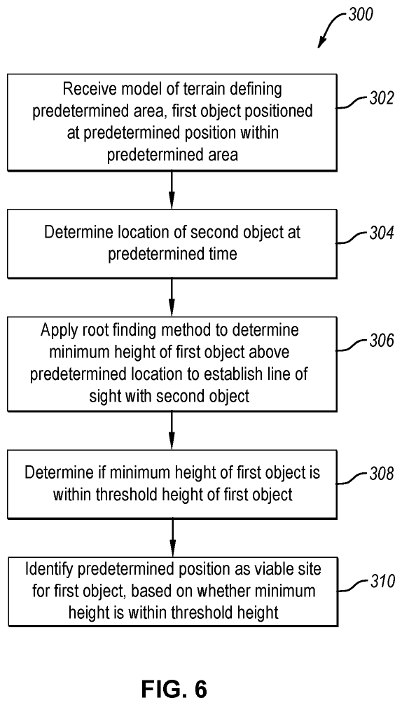

Referring to FIG. 6, according to some examples, a method 300 for determining a viable site for a first object 120 is shown. The method 300 includes the step of (block 302) receiving a digital model of a terrain defining a predetermined area. The digital model of the terrain includes a plurality of elements having a corresponding elevation within the predetermined area. The first object is configured to be positioned at a predetermined position within the predetermined area. The method 300 also includes the step of (block 304) determining a location of a second object at a predetermined time. In some examples, the second object is a movable object, and therefore this step determines the location at a specific time. The temporal dimension is important for determining if any of the plurality of elements of the digital model of the terrain are between the first object and the second object at the predetermined time.

The method 300 further includes the step of (block 306) applying a root finding method, based on the digital model of the terrain, to determine a minimum height of the first object above the predetermined position to establish a line of sight with the second object at the predetermined time. Accordingly, the goal of the root finding method is to establish an unobstructed line of sight from the first object to the second object at the specified time, considering the elevations of corresponding elements in the digital model of the terrain. In some examples, the root finding method is a bisection method that iteratively narrows down a search interval by halving it at each iteration until the minimum height is found within a specified tolerance. The method 300 additionally includes the step of (block 308) determining whether the minimum height of the first object is within a threshold height of the first object. This assessment ensures that the determined height is within the acceptable range of the first object. The method 300 also includes the step of (block 310) identifying the predetermined position as a viable site for the first object based on whether the minimum height of the first object is within the threshold height of the first object.

In some examples, the method 300 includes designing a product based on the first object. The product is configured to be positioned at the predetermined position, within the predetermined area, of the digital model of the terrain. The product is configured to be placed at least at the minimum height, calculated during the root finding method. Additionally, the method 300 may include verification and validation of previously designed products.

Additionally, in some examples, the method 300 includes fabricating a physical product of the designed product, based on the first object. Fabricating the physical product entails the process of physically constructing the designed product based on the specifications derived from the first object. This typically involves manufacturing operations such as forming, assembling, and completing a tangible object ready for installation or deployment. The fabrication process ensures that the designed product is translated accurately from digital models to physical reality, adhering to required standards and functional requirements. The physical product is configured to be positioned at the predetermined positioned, within the predetermined area, of a terrain represented by the digital model of the terrain. The physical product is fabricated to be able to be positioned at least at the minimum height at the predetermined position.

Further, in some examples, the method 300 includes installing a product based on the first object at the predetermined position, within the predetermined area, of a terrain represented by the digital model of the terrain. The product is configured to be installed at least at the minimum height, above the predetermined position. Installation may include optimizing an object orientation of the first object. For example, an orientation of the first object may be optimized to ensure maximum exposure to sunlight, minimize shading, or optimize communication angles.

In the above description, certain terms may be used such as “up,” “down,” “upper,” “lower,” “horizontal,” “vertical,” “left,” “right,” “over,” “under” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object. Further, the terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise. Further, the term “plurality” can be defined as “at least two.”

Additionally, instances in this specification where one element is “coupled” to another element can include direct and indirect coupling. Direct coupling can be defined as one element coupled to and in some contact with another element. Indirect coupling can be defined as coupling between two elements not in direct contact with each other, but having one or more additional elements between the coupled elements. Further, as used herein, securing one element to another element can include direct securing and indirect securing. Additionally, as used herein, “adjacent” does not necessarily denote contact. For example, one element can be adjacent another element without being in contact with that element.

As used herein, the phrase “at least one of”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example, without limitation, two of item A, one of item B, and ten of item C; four of item B and seven of item C; or some other suitable combination.

Unless otherwise indicated, the terms “first,” “second,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

As used herein, a system, apparatus, structure, article, element, component, or hardware “configured to” perform a specified function is indeed capable of performing the specified function without any alteration, rather than merely having potential to perform the specified function after further modification. In other words, the system, apparatus, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware which enable the system, apparatus, structure, article, element, component, or hardware to perform the specified function without further modification. For purposes of this disclosure, a system, apparatus, structure, article, element, component, or hardware described as being “configured to” perform a particular function may additionally or alternatively be described as being “adapted to” and/or as being “operative to” perform that function.

The schematic flow chart diagrams included herein are generally set forth as logical flow chart diagrams. As such, the depicted order and labeled steps are indicative of one example of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, comprise one or more physical or logical blocks of executable code which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for examples may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The described features, structures, or characteristics of the examples may be combined in any suitable manner. In the above description, numerous specific details are provided, such as examples of programming, software modules, user selections, network transactions, database queries, database structures, hardware modules, hardware circuits, hardware chips, etc., to provide a thorough understanding of examples. One skilled in the relevant art will recognize, however, that examples may be practiced without one or more of the specific details, or with other methods, components, materials, and so forth. In other instances, well-known structures, materials, or operations are not shown or described in detail to avoid obscuring aspects of an example.

Aspects of the examples are described above with reference to schematic flowchart diagrams and/or schematic block diagrams of methods, apparatuses, systems, and program products according to examples. It will be understood that each block of the schematic flowchart diagrams and/or schematic block diagrams, and combinations of blocks in the schematic flowchart diagrams and/or schematic block diagrams, can be implemented by code. These code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the figures illustrate the architecture, functionality, and operation of possible implementations of apparatuses, systems, methods and program products according to various examples. In this regard, each block in the schematic flowchart diagrams and/or schematic block diagrams may represent a module, segment, or portion of code, which comprises one or more executable instructions of the code for implementing the specified logical function(s).

The present subject matter may be embodied in other specific forms without departing from its spirit or essential characteristics. The described examples are to be considered in all respects only as illustrative and not restrictive. All changes which come within the meaning and range of equivalency of the examples herein are to be embraced within their scope.

What is claimed is:

1. An apparatus for determining a viable site for a first object, comprising:
a processor; and
a memory that stores code executable by the processor to:
receive a digital model of a terrain defining a predetermined area, the digital model of the terrain comprising a plurality of elements having a corresponding elevation within the predetermined area, wherein the first object is configured to be positioned at a predetermined position within the predetermined area;
determine a location of a second object at a predetermined time;
apply a root finding method, based on the digital model of the terrain, to determine a minimum height of the first object above the predetermined position to establish a line of sight with the second object at the predetermined time;
determine whether the minimum height of the first object is within a threshold height of the first object; and
identify the predetermined position as a viable site for the first object based on whether the minimum height of the first object is within the threshold height of the first object.

2. The apparatus of claim 1, wherein the root finding method comprises:
defining an initial search space for the first object comprising an initial minimum height and an initial maximum height, wherein at the initial minimum height the first object lacks line of sight with the second object, and wherein at the initial maximum height the first object establishes line of sight with the second object;
applying a root finding calculation to determine an intermediate height of the first object by dividing the initial search space between the initial minimum height and the initial maximum height;
defining a current search space for the first object based on the root finding calculation, the current search space comprising a current minimum height and a current maximum height; and
iteratively refining the current search space of the first object using the root finding calculation to converge upon the minimum height of the first object above the predetermined position to establish line of sight with the second object.

3. The apparatus of claim 2, wherein the step of iteratively refining the current search space further comprises defining a tolerance value configured to control a precision of the minimum height, such that iteratively refining the current search space continues until a difference between the current maximum height and the current minimum height is less than or equal to the tolerance value.

4. The apparatus of claim 2, wherein the root finding method further comprises optimizing within the initial search space using an optimization value to determine an optimized search space for the first object defining an optimized minimum height and an optimized maximum height, wherein the step of applying the root finding calculation comprises determining the intermediate height of the first object by dividing the optimized search space between the optimized minimum height and the optimized maximum height.

5. The apparatus of claim 2, wherein the root finding method comprises a bisection method.

6. The apparatus of claim 1, wherein:
the first object is a solar-tracking device; and
the second object is a sun.

7. The apparatus of claim 1, wherein:
the digital model of the terrain comprises a representation of a surface topology of a planetary body; and
each one of the plurality of elements within the predetermined area is associated with specific geographical coordinates.

8. The apparatus of claim 1, wherein the line of sight established between the first object and the second object is configured to transmit at least one of various signals between the first object and the second object including at least one of electromagnetic waves, communication waves, or acoustic waves.

9. The apparatus of claim 1, wherein when the minimum height of the first object is within the threshold height, the code stored by the memory is further executable by the processor to design a signal-receiving product or a signal-transmitting product based on the first object, wherein the signal-receiving product or the signal-transmitting product is configured to be positioned at the predetermined position within the predetermined area, and a height of the signal-receiving product or the signal-transmitting product is configured to be at least the minimum height.

10. The apparatus of claim 1, wherein when the minimum height of the first object is beyond the threshold height, the memory further stores code executable by the processor to:
define a subsequent position that the first object is configured to be positioned within the predetermined area;
apply the root finding method to determine a subsequent minimum height of the first object above the subsequent position to establish the line of sight with the second object;
determine whether the subsequent minimum height is within the threshold height of the first object; and
identify the subsequent position as a viable site for the first object based on whether the minimum height of the first object is within the threshold height of the first object.

11. The apparatus of claim 1, wherein the memory further stores code executable by the processor to:
determine a second location of the second object at a second predetermined time;
apply the root finding method to determine a second minimum height of the first object above the predetermined position to establish the line of sight with the second object; and
determine whether the second minimum height of the first object is within the threshold height of the first object.

12. A method for determining a viable site for a first object, comprising:
receiving a digital model of a terrain defining a predetermined area, the digital model of the terrain comprising a plurality of elements having a corresponding elevation within the predetermined area, wherein the first object is configured to be positioned at a predetermined position within the predetermined area;
determining a location of a second object at a predetermined time;
applying a root finding method, based on the digital model of the terrain, to determine a minimum height of the first object above the predetermined position to establish a line of sight with the second object at the predetermined time;
determining whether the minimum height of the first object is within a threshold height of the first object; and
identifying the predetermined position as a viable site for the first object based on whether the minimum height of the first object is within the threshold height of the first object.

13. The method of claim 12, wherein the root finding method comprises:
defining an initial search space for the first object comprising an initial minimum height and an initial maximum height, wherein at the initial minimum height the first object lacks line of sight with the second object, and wherein at the initial maximum height the first object establishes line of sight with the second object;
applying a root finding calculation to determine an intermediate height of the first object by dividing the initial search space between the initial minimum height and the initial maximum height,
defining a current search space for the first object based on the root finding calculation, the current search space comprising a current minimum height and a current maximum height; and
iteratively refining the current search space of the first object using the root finding calculation to converge upon the minimum height of the first object above the predetermined position to establish line of sight with the second object.

14. The method of claim 13, wherein the step of iteratively refining the current search space further comprises defining a tolerance value configured to control a precision of the minimum height, such that iteratively refining the current search space continues until a difference between the current maximum height and the current minimum height is less than or equal to the tolerance value.

15. The method of claim 12, wherein when the minimum height of the first object is within the threshold height, the method further comprises designing a product based on the first object, wherein the product is configured to be positioned at the predetermined position within the predetermined area, and a height of the product is configured to be at least the minimum height.

16. The method of claim 12, wherein when the minimum height of the first object is within the threshold height, the method further comprises fabricating a product based on the first object, wherein the product is configured to be positioned at the predetermined position within the predetermined area, and a height of the product is configured to be at least the minimum height.

17. The method of claim 12, wherein when the minimum height of the first object is within the threshold height, the method further comprises installing a product based on the first object at the predetermined position within the predetermined area, wherein a height of the product above the predetermined position is at least the minimum height.

18. A program product for determining a viable site for a first object, comprising a non-transitory computer-readable storage medium storing executable code, the code configured to be executable by a processor to perform operations comprising:
receiving a digital model of a terrain defining a predetermined area, the digital model of the terrain comprising a plurality of elements having a corresponding elevation within the predetermined area, wherein the first object is configured to be positioned at a predetermined position within the predetermined area;
determining a location of a second object at a predetermined time;
applying a root finding method, based on the digital model of the terrain, to determine a minimum height of the first object above the predetermined position to establish a line of sight with the second object at the predetermined time;
determining whether the minimum height of the first object is within a threshold height of the first object; and
identifying the predetermined position as a viable site for the first object based on whether the minimum height of the first object is within the threshold height of the first object.

19. The program product of claim 18, wherein when the minimum height of the first object is within the threshold height, the program product further comprises designing a product based on the first object, wherein the product is configured to be positioned at the predetermined position within the predetermined area, and a height of the product is configured to be at least the minimum height.

20. The program product of claim 18, wherein the root finding method comprises:
defining an initial search space for the first object comprising an initial minimum height and an initial maximum height, wherein at the initial minimum height the first object lacks line of sight with the second object, and wherein at the initial maximum height the first object establishes line of sight with the second object;
applying a root finding calculation to determine an intermediate height of the first object by dividing the initial search space between the initial minimum height and the initial maximum height;
defining a current search space for the first object based on the root finding calculation, the current search space comprising a current minimum height and a current maximum height; and
iteratively refining the current search space of the first object using the root finding calculation to converge upon the minimum height of the first object above the predetermined position to establish line of sight with the second object.
